(19) United States
(12) Patent Application Publication
(10) Pub. No.: US 2026/0159673 A1
(43) Pub. Date: Jun. 11, 2026

(54) RUBBER COMPOSITION FOR COVERING STEEL CORD AND PNEUMATIC TIRE

(71) Applicant: Toyo Tire Corporation, Itami-shi (JP)

(72) Inventor: Yuta Takata, Itami-shi (JP)

(73) Assignee: Toyo Tire Corporation, Itami-shi (JP)

(21) Appl. No.: 19/414,863

(22) Filed: Dec. 10, 2025

(30) Foreign Application Priority Data
Dec. 11, 2024 (JP) 2024-216367

(51) Int. Cl. C08L 7/00; B60C 1/00; B60C 9/00; C08K 5/098; C08K 5/3492

(52) U.S. Cl. CPC C08L 7/00; B60C 1/0041; C08K 5/098; C08K 5/34922; B60C 2001/0066; B60C 9/0007; B60C 2009/0021; C08L 2205/03; C08L 2207/322

(57) ABSTRACT

A rubber composition for covering a steel cord according to an embodiment includes a diene rubber, a vegetable oil, a melamine derivative, and a resorcinol-based compound. A pneumatic tire according to an embodiment includes a rubber-steel cord composite in which a rubber composition for covering a steel cord, including a diene rubber, a vegetable oil, a melamine derivative, and a resorcinol-based compound, is vulcanization-bonded to steel cords.

### BACKGROUND OF THE INVENTION

### 1. Field of the Invention

The present invention relates to a rubber composition for covering a steel cord and also to a pneumatic tire using the same.

### 2. Description of Related Art

In pneumatic tires, particularly in radial tires, steel cords are often used as reinforcing materials for belt layers of passenger car tires, and also for belts, carcass plies, and chafers of large tires for trucks, buses, and the like, for example. Nowadays, the service life of tires has been extended, and it has become increasingly important to enhance the reinforcing effect of steel cords and maintain the durability over a long period of time. Thus, the rubber composition that covers steel cords is required to have excellent adhesiveness to steel cords.

It is known that in order to improve adhesiveness to steel cords, a resorcinol-based compound such as resorcinol or a resorcinol derivative is incorporated into a rubber composition for covering a steel cord. For example, JP2021-195413 A describes a rubber-steel cord composite having excellent initial adhesiveness and wet heat adhesiveness, in which a rubber composition incorporating a resorcinol-based compound and a melamine derivative is vulcanization-bonded to steel cords.

WO2002/050206 discloses a resorcinol derivative that can replace resorcinol during rubber production. In addition, a rubber composition in which the resorcinol derivative is incorporated as a methylene acceptor together with a methylene donor is disclosed.

JP2009-40347A discloses a belt-like ply in which a cord arrangement body is covered with a topping rubber composed mainly of raw materials from non-petroleum resources. In addition, it is described that in the topping rubber, a vegetable oil is incorporated as an extender oil, and a resorcinol derivative is incorporated as an adhesive.

### SUMMARY OF THE INVENTION

As a measure to address global environmental problems, it is desirable that sustainable raw materials, such as those derived from biomass resources, are used instead of petroleum-derived raw materials. Currently, as oil components to be incorporated from the viewpoint of processability during the preparation of rubber compositions for tires, petroleum-based oils (e.g., aromatic oils) are mainly used. Therefore, from the viewpoint of sustainability, it is desirable to develop rubber compositions in which petroleum-based oils are replaced with sustainable raw materials.

In light of the above points, an object of an embodiment of the invention is to provide a rubber composition for covering a steel cord, which can improve sustainability and adhesiveness to steel cords without impairing processability.

The invention includes the following embodiments.

[1] A rubber composition for covering a steel cord, including a diene rubber, a vegetable oil, a melamine derivative, and a resorcinol-based compound.

[2] The rubber composition for covering a steel cord according to [1], in which the content of the vegetable oil is 1 to 10 parts by mass per 100 parts by mass of the diene rubber.

[3] The rubber composition for covering a steel cord according to [1] or [2], in which per 100 parts by mass of the diene rubber, the content of the melamine derivative is 0.1 to 5 parts by mass, and the content of the resorcinol-based compound is 0.1 to 5 parts by mass.

[4] The rubber composition for covering a steel cord according to any one of [1] to [3], in which the vegetable oil has an iodine value of 60 to 140.

[5] The rubber composition for covering a steel cord according to any one of [1] to [4], in which the diene rubber includes natural rubber.

[6] The rubber composition for covering a steel cord according to any one of [1] to [5], which does not include petroleum-based oils.

[7] The rubber composition for covering a steel cord according to any one of [1] to [6], further including an organic acid cobalt salt.

[8] A pneumatic tire including a rubber-steel cord composite having the rubber composition for covering a steel cord according to any one of [1] to [7] vulcanization-bonded to a steel cord.

According to embodiments of the invention, sustainability and adhesiveness to steel cords can be improved without impairing processability.

### DESCRIPTION OF EMBODIMENTS

The rubber composition for covering a steel cord according to this embodiment (hereinafter also referred to as “rubber composition”) contains (A) a diene rubber, (B) a vegetable oil, (C) a melamine derivative, and (D) a resorcinol-based compound. As a result of incorporating a vegetable oil together with a melamine derivative and a resorcinol-based compound in this way, adhesiveness to steel cords can be improved without impairing processability. Although not intended to be limiting, the reason for this is presumed to be as follows.

When a melamine derivative (methylene donor) and a resorcinol-based compound (methylene acceptor) are incorporated as additives in a rubber composition, the methylene group of the melamine derivative reacts with the hydroxyl group of the resorcinol-based compound during the vulcanization of the rubber composition. As a result of the occurrence of the above reaction, a mesh-like, highly stable resin layer is formed inside the vulcanized rubber. In particular, the above reaction proceeds preferentially at the rubber-metal adhesion interface. Therefore, a stronger resin layer is presumably formed at the rubber-metal adhesion interface, resulting in an improving effect on wet heat adhesiveness. Incidentally, in a rubber composition for covering a steel cord, generally, a petroleum-derived aromatic oil is incorporated in order to improve processability. Such aromatic oils have a chemical structure similar to that of resorcinol-based compounds, and thus presumably compete with resorcinol-based compounds in the reaction with a melamine derivative. In contrast, vegetable oils have a linear chemical structure, which is significantly different from the chemical structure of resorcinol-based compounds. Therefore, presumably no competition occurs, resulting in the formation of a stronger resin layer at the rubber-metal adhesion interface, leading to improved adhesiveness. In addition, as a result of using a vegetable oil instead of a petroleum-derived aromatic oil as an oil component, a rubber composition that is desirable not only from the viewpoint of rubber-metal adhesiveness but also from the viewpoint of sustainability can be obtained.

### [(A) Diene Rubber]

In this embodiment, a diene rubber refers to a rubber with a repeating unit corresponding to a diene monomer having a conjugated double bond, and contains a carbon-carbon double bond in the polymer backbone. Specific examples of diene rubbers include various diene rubbers commonly used in rubber compositions, such as natural rubber (NR), synthetic isoprene rubber (IR), polybutadiene rubber (BR), styrene butadiene rubber (SBR), nitrile rubber (NBR), chloroprene rubber (CR), styrene-isoprene copolymer rubbers, butadiene-isoprene copolymer rubbers, and styrene-isoprene-butadiene copolymer rubbers. The concept of these diene rubbers also encompasses those modified at the terminal or backbone as necessary (e.g., terminally modified SBR) and those reformed to impart desired characteristics (e.g., reformed NR). Any one of these diene rubbers may be used, and it is also possible to use two or more kinds together. Among them, the diene rubber is preferably at least one selected from the group consisting of natural rubber, synthetic isoprene rubber, butadiene rubber, and styrene-butadiene rubber.

In one embodiment, the diene rubber preferably includes natural rubber. The amount of natural rubber in 100 parts by mass of the diene rubber is not particularly limited, and may be 50 parts by mass or more, 60 parts by mass or more, 70 parts by mass or more, 80 parts by mass or more, 90 parts by mass or more, or 100 parts by mass.

### [(B) Vegetable Oil]

The rubber composition according to this embodiment contains a vegetable oil as an oil component. A vegetable oil refers to an oil or fat extracted from the seeds, fruits, kernels, or the like of plants. The vegetable oil may be solid or liquid at room temperature (25° C.). The term “solid” refers to a state that does not have fluidity, and “liquid” refers to a state that has fluidity. From the viewpoint of sustainability, it is preferable to contain no petroleum-based oil as an oil component.

As specific examples of vegetable oils, flaxseed oil, soybean oil, sunflower oil, palm oil, palm olein, palm kernel oil, olive oil, rapeseed oil, sesame oil, cottonseed oil, safflower oil, rice bran oil, corn oil, coconut oil, peanut oil, grape oil, and the like can be mentioned. Any one of them, or a combination of two or more kinds, may be used.

In one embodiment, the iodine value of the vegetable oil is preferably 60 to 140, and more preferably 65 to 130. Here, the iodine value is a value calculated as the amount of iodine (g) converted from the amount of halogen bound when a halogen is allowed to react with 100 g of a sample, and is measured in accordance with JIS K0070:1992. The iodine value correlates with the amount of unsaturated bonds in fatty acids contained in the vegetable oil, and a higher iodine value indicates a greater amount of unsaturated bonds in fatty acids contained in the vegetable oil.

The unsaturated bond portions in fatty acids contained in a vegetable oil have high electron reactivity and thus react with sulfur. When the iodine value of a vegetable oil is 140 or less, excessive consumption of sulfur due to the reaction between the unsaturated bond portions in fatty acids contained in the vegetable oil and sulfur can be suppressed. Accordingly, a decrease in the crosslinking density of the vulcanized rubber is suppressed, making it easier to strengthen the bond between the resin layer and the rubber layer. In addition, when the iodine value of the vegetable oil is 60 or more, sulfur is consumed moderately through the reaction between the unsaturated bond portions in fatty acids contained in the vegetable oil and sulfur. Accordingly, the formation of a large amount of thermally unstable polysulfides in the vulcanized rubber can be suppressed, and the effect of this embodiment can be enhanced.

In one embodiment, the content of the vegetable oil is preferably 1 to 10 parts by mass, more preferably 1 to 8 parts by mass, and still more preferably 1 to 6 parts by mass per 100 parts by mass of the diene rubber. When the content of the vegetable oil is 1 part by mass or more per 100 parts by mass of the diene rubber, sufficient processability can be obtained. In addition, when the content of the vegetable oil is 10 parts by mass or less per 100 parts by mass of the diene rubber, the reinforcing properties of the vulcanized rubber are maintained. Thus, breakage is suppressed, and adhesiveness can be improved.

### [(C) Melamine Derivative]

The rubber composition according to this embodiment contains a melamine derivative. As specific examples of melamine derivatives, hexamethylolmelamine, hexamethoxymethylmelamine, hexaethoxymethylmelamine, hexakis-(methoxymethyl) melamine, pentamethoxymethylolmelamine, N,N′,N″-trimethyl-N,N′,N″-trimethylolmelamine, N,N′,N″-trimethylolmelamine, N-methylolmelamine, N,N′-(methoxymethyl) melamine, N,N′,N″-tributyl-N,N′,N″-trimethylolmelamine, and the like can be mentioned. Any one of them, or a combination of two or more kinds, may be used. As the melamine derivative, hexamethoxymethylmelamine is particularly preferably used.

In one embodiment, the content of the melamine derivative is preferably 0.1 to 5 parts by mass, more preferably 0.5 to 4 parts by mass, and still more preferably 1 to 3 parts by mass per 100 parts by mass of the diene rubber.

### [(D) Resorcinol-Based Compound]

The rubber composition according to this embodiment contains a resorcinol-based compound. Resorcinol-based compounds include resorcinol and resorcinol derivatives. As resorcinol derivatives, a resorcinol-formalin resin resulting from the condensation of resorcinol and formaldehyde, a resorcinol-alkylphenol-formalin resin resulting from the alkylation of some of the repeating units of the resorcinol-formalin resin, and further phenol-based resins such as a phenol-formalin resin and a cresol-formalin resin resulting from the condensation of phenols (phenol, cresol, etc.) and aldehydes can also be used. Any one of them, or a combination of two or more kinds, may be used. As the resorcinol-based compound, a resorcinol-alkylphenol-formalin resin or resorcinol is particularly preferably used.

In one embodiment, the content of the resorcinol-based compound is preferably 0.1 to 5 parts by mass, more preferably 0.5 to 4 parts by mass, and still more preferably 1 to 3 parts by mass per 100 parts by mass of the diene rubber.

The mass ratio of the melamine derivative relative to the resorcinol-based compound (melamine derivative/resorcinol-based compound) is not particularly limited, but is preferably 0.25 to 4, and more preferably 0.5 to 2.

### [Other Components]

In addition to the above components, the rubber composition according to this embodiment can incorporate various additives generally used in rubber compositions, such as fillers, zinc oxide, stearic acid, organic acid cobalt salts, vulcanizing agents, and vulcanization accelerators.

As fillers, carbon black and silica can be mentioned. They may be used either alone or together.

Carbon black is not particularly limited, and known various species can be used. Specifically, SAF grade (N 100 series), ISAF grade (N 200 series), HAF grade (N 300 series), FEF grade (N 500 series), GPF grade (N 600 series), SRF grade (N 700 series) (all ASTM grades), and the like can be mentioned. Any one of these carbon black species, or a combination of two or more kinds, can be used. The carbon black content is not particularly limited, and may be, for example, 20 to 100 parts by mass, 40 to 80 parts by mass, or 50 to 70 parts by mass per 100 parts by mass of the diene rubber.

Silica is not particularly limited, and wet silica, dry silica, and the like can be mentioned. As silica, it is preferable to use wet silica, such as wet-precipitated silica or wet-gelled silica. The silica content is not particularly limited, and may be, for example, 1 to 40 parts by mass, 3 to 30 parts by mass, or 5 to 20 parts by mass per 100 parts by mass of the diene rubber.

The zinc oxide content is not particularly limited, and may be, for example, 0 to 20 parts by mass, 3 to 15 parts by mass, or 5 to 10 parts by mass per 100 parts by mass of the diene rubber.

The stearic acid content is not particularly limited, and may be, for example, 0 to 10 parts by mass, 0.3 to 5 parts by mass, or 0.5 to 3 parts by mass per 100 parts by mass of the diene rubber.

The organic acid cobalt salt is preferably incorporated as an agent for improving adhesiveness to steel cords. As organic acid cobalt salts, for example, cobalt oleate, cobalt stearate, cobalt naphthenate, cobalt neodecanoate, cobalt borate, cobalt maleate, and cobalt rosinate can be mentioned, and, among them, cobalt stearate is particularly preferably used. The organic acid cobalt salt content is not particularly limited, and may be, for example, 0.03 to 0.50 parts by mass in terms of metal content per 100 parts by mass of the diene rubber.

As vulcanizers, for example, powder sulfur, precipitated sulfur, colloidal sulfur, insoluble sulfur, highly dispersed sulfur, and like sulfur can be mentioned. The vulcanizing agent content is not particularly limited, and may be, for example, 1 to 10 parts by mass, 2 to 9 parts by mass, or 4 to 8 parts by mass per 100 parts by mass of the diene rubber.

As vulcanization accelerators, for example, sulfenamide-based, thiuram-based, thiazole-based, guanidine-based, and like various vulcanization accelerators can be mentioned. Any one of them, or a combination of two or more kinds, can be used. The vulcanization accelerator content is not particularly limited, and may be, for example, 0 to 5 parts by mass, 0.3 to 3 parts by mass, or 0.5 to 3 parts by mass per 100 parts by mass of the diene rubber.

The rubber composition according to this embodiment can be prepared by kneading in the usual manner using a commonly used mixing machine, such as a Banbury mixer, a kneader, or a roll. That is, in the first mixing stage, additives other than a vulcanizing agent and a vulcanization accelerator are added to a diene rubber and mixed. Next, in the final mixing stage, a vulcanizing agent and a vulcanization accelerator are added to the obtained mixture, whereby a rubber composition can be prepared.

The rubber composition can be used as a rubber composition for covering various steel cords, and a rubber-steel cord composite in which the rubber composition is vulcanization-bonded to steel cords is obtained. Such a rubber-steel cord composite can be produced by vulcanizing the rubber composition while in contact with the steel cords. The heating temperature during vulcanization is not particularly limited, and may be 140 to 180° C., for example. As steel cords, those surface-plated with brass, bronze, zinc, or the like are preferably used. It is more preferable to use brass-plated steel cords.

The rubber-steel cord composite can be used as a reinforcing material for tires, for use in belts, carcass plies, chafers, and the like of pneumatic tires, or as a reinforcing material for reinforcing industrial belt members and the like. Use as a reinforcing material for pneumatic tires is preferable. Accordingly, a pneumatic tire according to this embodiment includes the rubber-steel cord composite described above.

In the case of use as a reinforcing material for belts, carcass plies, chafers, and the like of pneumatic tires, steel cords are topped with the rubber composition in the usual manner using a topping apparatus such as a steel calender to produce a steel cord topping sheet. Then, an unvulcanized tire is prepared using this sheet as a belt, carcass ply, chafer, or the like, followed by vulcanization-molding at 140 to 180° C., for example, whereby a pneumatic tire can be produced.

The pneumatic tire is not particularly limited and may be a tire for passenger cars or a heavy-duty tire for trucks, buses, and the like. The structure of a pneumatic tire itself is well known and is not particularly limited. A pneumatic tire generally includes a pair of left and right bead parts and sidewalls, as well as a tread provided between the left and right sidewalls so as to connect the radially outer ends of the sidewalls to each other. In addition, it commonly includes at least one carcass ply extending between the pair of left and right bead parts. The carcass ply extends from the tread through the sidewalls and is anchored at both ends with the bead parts, serving to reinforce the above parts. In addition, on the outer peripheral side of the carcass ply in the tread, a belt (usually two or more layers) is provided between the carcass ply and the tread rubber, serving to reinforce the tread on the outer periphery of the carcass ply. A chafer is embedded in the bead part to reinforce the bead part. In the case where the rubber-steel cord composite is used as a reinforcing material for tires, it may be applied to one of a belt, a carcass, and a chafer or may also be applied to two or more of them.

### EXAMPLES

Hereinafter, examples of the invention will be shown, but the invention is not limited to these examples.

The raw materials used in the examples and comparative examples are as follows.
Natural rubber: RSS #3
Carbon black: HAF-LS, “N326 SEAST 300” manufactured by Tokai Carbon Co., Ltd.
Silica: “Nipsil AQ” manufactured by Tosoh Silica Corporation
Petroleum-based oil: “PROCESS NC-140” manufactured by ENEOS Corporation
Vegetable oil-1: Sunflower oil, “High Oleic Sunflower Oil NS” (iodine value=84) manufactured by J-Oil Mills, Inc.
Vegetable oil-2: Soybean oil, “Soybean Refined Oil” (iodine value=128) manufactured by Nisshin Oillio Group, Ltd.
Vegetable oil-3: Palm olein, “PL65” (iodine value=65) manufactured by Nisshin Oillio Group, Ltd.
Melamine derivative: Hexamethoxymethylmelamine, “CYREZ 963L” manufactured by Allnex Japan Inc.
Resorcinol derivative: Resorcinol-alkylphenol-formalin resin, “Sumikanol 620” manufactured by Sumitomo Chemical Co., Ltd.
Zinc oxide: “Zinc Oxide, Type 3” manufactured by Mitsui Mining & Smelting Co., Ltd.
Stearic acid: “LUNAC S-20” manufactured by Kao Corporation
Cobalt stearate: “Corebond CS-9.5” (Co content: 9.5 mass %) manufactured by Taiko Fine Chemicals Co., Ltd.
Sulfur: “Powder Sulfur” manufactured by Tsurumi Chemical Industry Co., Ltd.
Vulcanization accelerator: “Nocceler DZ-G” manufactured by Ouchi Shinko Chemical Industrial Co., Ltd.

The evaluation methods in the examples and comparative examples are as follows.

### [Processability]

In accordance with JIS K6300-1:2013, using a rotorless Mooney viscometer manufactured by Toyo Seiki Seisaku-sho, Ltd., an unvulcanized rubber composition was preheated at 100° C. for 1 minute, and the torque value after 4 minutes was measured in Mooney units. With respect to the reciprocals of the measured torque values, the values of the examples and comparative examples are each shown as an index taking the value of Comparative Example 1 in Table 1, and the value of Comparative Example 3 in Table 2, as 100. The larger the index, the lower the Mooney viscosity, indicating better processability. The target value for processability is 95 or more.

### [Wet Heat Adhesiveness]

Using each obtained rubber composition, an unvulcanized sample of a composite of the rubber composition and steel cords (rubber-steel cord composite) was prepared. Specifically, steel cords for belts (3×0.20+6×0.35 mm structure, copper/zinc=64/36 (mass ratio), and brass plating of an adhesion amount of 5 g/kg) were arranged in parallel with a driving density of 12 pieces/25 mm, and both sides thereof were each covered with a 1-mm-thick rubber sheet composed of the rubber composition. Two such layers were then laminated in such a manner that the cords were parallel to each other, thereby preparing an unvulcanized sample. The prepared unvulcanized sample was left at room temperature for 24 hours and then vulcanized at 150° C. for 30 minutes. The vulcanized test piece was left in saturated steam at 105° C. for 96 hours, and then the peel strength between the two steel cord layers was determined by a peel test using an autograph “DCS500” manufactured by Shimadzu Corporation. With respect to the measured peel strength values, the values of the examples and comparative examples are each shown as an index taking the value of Comparative Example 1 in Table 1, and the value of Comparative Example 3 in Table 2, as 100. A larger index indicates better wet heat adhesiveness.

### First Experiment Example

According to the formulation (parts by mass) shown in Table 1 below, rubber compositions of Comparative Examples 1 and 2 and Examples 1 to 5 were prepared using a Banbury mixer. Specifically, first, in the first mixing stage, all additives except for sulfur and a vulcanization accelerator were added and kneaded (discharge temperature=160° C.). In the final mixing stage, sulfur and a vulcanization accelerator were added to the resulting kneaded product and kneaded (discharge temperature=90° C.) to prepare a rubber composition. The processability and wet heat adhesiveness of each obtained rubber composition were evaluated.

The results are as shown in Table 1 below. In Table 1, only carbon black was used as a filler. Comparative Example 1 is a conventional formulation system that uses a petroleum-based oil as an oil component. In Comparative Example 2 where no oil component was used, compared to Comparative Example 1, the processability significantly decreased, falling below the target value, and the wet heat adhesiveness was also slightly inferior.

In contrast, in Examples 1 to 5 where vegetable oils having various iodine values were used as oil components, compared to Comparative Example 1, while the processability was equivalent or better, the wet heat adhesiveness improved.

TABLE 1

| | Comp. | Comp. | | | | | |
|---|---|---|---|---|---|---|---|
| | Ex. 1 | Ex. 2 | Ex. 1 | Ex. 2 | Ex. 3 | Ex. 4 | Ex. 5 |
| Formulation | | | | | | | |
| (parts by mass) | | | | | | | |
| Natural Rubber | 100 | 100 | 100 | 100 | 100 | 100 | 100 |
| Carbon Black | 60 | 60 | 60 | 60 | 60 | 60 | 60 |
| Petroleum-Based Oil | 3 | | | | | | |
| Vegetable Oil-1 | | | 3 | 1.5 | 6 | | |
| Vegetable Oil-2 | | | | | | 3 | |
| Vegetable Oil-3 | | | | | | | 3 |
| Melamine Derivative | 2 | 2 | 2 | 2 | 2 | 2 | 2 |
| Resorcinol Derivative | 2 | 2 | 2 | 2 | 2 | 2 | 2 |
| Zinc Oxide | 8 | 8 | 8 | 8 | 8 | 8 | 8 |
| Stearic Acid | 1 | 1 | 1 | 1 | 1 | 1 | 1 |
| Cobalt Stearate | 2 | 2 | 2 | 2 | 2 | 2 | 2 |
| Sulfur | 6 | 6 | 6 | 6 | 6 | 6 | 6 |
| Vulcanization Accelerator | 1 | 1 | 1 | 1 | 1 | 1 | 1 |
| Evaluation (Index) | | | | | | | |
| Processability | 100 | 82 | 99 | 96 | 107 | 100 | 101 |
| Wet Heat Adhesiveness | 100 | 98 | 110 | 107 | 103 | 101 | 104 |

### Second Experiment Example

Rubber compositions of Comparative Example 3 and Example 6 were prepared in the same manner as in the first experiment example, except for following the formulation (parts by mass) shown in Table 2 below. The processability and wet heat adhesiveness of each obtained rubber composition were evaluated.

The results are as shown in Table 2 below. In Table 2, carbon black and silica were used together as fillers. Comparative Example 3 is a conventional formulation system that uses a petroleum-based oil as an oil component. In contrast, in Example 6 where a vegetable oil (sunflower oil) was used as an oil component, compared to Comparative Example 3, while the processability was equivalent, the wet heat adhesiveness significantly improved.

TABLE 2

| | Comp. | |
|---|---|---|
| | Ex. 3 | Ex. 6 |
| Formulation | | |
| (parts by mass) | | |
| Natural Rubber | 100 | 100 |
| Carbon Black | 60 | 60 |
| Silica | 10 | 10 |
| Petroleum-Based Oil | 3 | |
| Vegetable Oil-1 | | 3 |
| Melamine Derivative | 2 | 2 |
| Resorcinol Derivative | 2 | 2 |
| Zinc Oxide | 8 | 8 |
| Stearic Acid | 1 | 1 |
| Cobalt Stearate | 2 | 2 |
| Sulfur | 6 | 6 |
| Vulcanization Accelerator | 1 | 1 |
| Evaluation (Index) | | |
| Processability | 100 | 100 |
| Wet Heat Adhesiveness | 100 | 113 |

Incidentally, with respect to the various numerical ranges described herein, the upper and lower limits thereof can be arbitrarily combined, and all such combinations are incorporated herein as preferred numerical ranges. In addition, the description of a numerical range “X to Y” means X or more and Y or less.

Although some embodiments of the invention have been described above, these embodiments are presented as examples and not intended to limit the scope of the invention. These embodiments can be implemented in other various modes, and various omissions, substitutions, and changes can be made thereto without departing from the gist of the invention. These embodiments, as well as omissions, substitutions, and changes thereto, etc., fall within the scope and gist of the invention, and also fall within the scope of the claimed invention and its equivalents.

What is claimed is:

1. A rubber composition for covering a steel cord, comprising a diene rubber, a vegetable oil, a melamine derivative, and a resorcinol-based compound.

2. The rubber composition for covering a steel cord according to claim 1, wherein the content of the vegetable oil is 1 to 10 parts by mass per 100 parts by mass of the diene rubber.

3. The rubber composition for covering a steel cord according to claim 1, wherein per 100 parts by mass of the diene rubber, the content of the melamine derivative is 0.1 to 5 parts by mass, and the content of the resorcinol-based compound is 0.1 to 5 parts by mass.

4. The rubber composition for covering a steel cord according to claim 1, wherein the vegetable oil has an iodine value of 60 to 140.

5. The rubber composition for covering a steel cord according to claim 1, wherein the diene rubber includes natural rubber.

6. The rubber composition for covering a steel cord according to claim 1, which does not comprise petroleum-based oils.

7. The rubber composition for covering a steel cord according to claim 1, further comprising an organic acid cobalt salt.

8. A pneumatic tire comprising a rubber-steel cord composite having the rubber composition for covering a steel cord according to claim 1 vulcanization-bonded to a steel cord.
